(19) United States
(12) Patent Application Publication
(10) Pub. No.: US 2026/0087593 A1
(43) Pub. Date: Mar. 26, 2026

(54) IMAGE FEATURE ENHANCEMENT METHOD AND ELECTRONIC DEVICE

(71) Applicant: ASUSTeK COMPUTER INC., Taipei (TW)

(72) Inventors: Hsien-Yang Li, Taipei (TW); Fou-Ming Liou, Taipei (TW); Jia-Lin Yang, Taipei (TW)

(21) Appl. No.: 19/280,525

(22) Filed: Jul. 25, 2025

(30) Foreign Application Priority Data
Sep. 23, 2024 (TW) 113136041

(51) Int. Cl. G06T 5/50; G06T 5/70; G06T 5/92; G06T 11/00

(52) U.S. Cl. CPC G06T 5/50; G06T 5/70; G06T 5/92; G06T 11/10; G06T 2207/10024; G06T 2207/20221; G06T 2210/41

(57) ABSTRACT

An image feature enhancement method and an electronic device are provided. The image feature enhancement method includes: blurring an original image to obtain a first blurred image; calculating a difference between the original image and the first blurred image to extract a first texture feature image; performing gamma correction on the first blurred image and the first texture feature image respectively to generate a second blurred image and a second texture feature image; and merging the second blurred image and the second texture feature image to generate a final image with enhanced features. The texture feature structure of the image can be quickly enhanced to make the image look clearer.

### CROSS-REFERENCE TO RELATED APPLICATION

This application claims the priority benefit of Taiwan Application Serial No. 113136041, filed on Sep. 23, 2024. The entirety of the above-mentioned patent application is hereby incorporated by reference herein and made a part of specification.

### BACKGROUND OF THE INVENTION

### Field of the Invention

The disclosure relates to an image feature enhancement method and an electronic device that enhances image features.

### Description of the Related Art

In general image processing, for an image that is not clear, a conventional method is usually to perform post-processing using an editing tool like Photoshop to make the image clearer. However, if the result yield is not satisfactory and the photographer has already left the photography spot, there may not be another chance to recapture the image. In addition, there is also a method of using an artificial intelligence (AI) model to calculate and improve image definition, but such method has high requirements on hardware, resulting in increased device costs. In addition, due to heavy computational load, the battery life of portable mobile devices is also affected.

In addition, in medical imaging, like gastroscopy or enteroscopy, an additional light source is usually required to display image features, like in narrow band imaging (NBI). However, this not only increases device costs but also increases a risk of device damage.

### BRIEF SUMMARY OF THE INVENTION

The disclosure provides an image feature enhancement method, including: blurring an original image to obtain a first blurred image; calculating a difference between the original image and the first blurred image to extract a first texture feature image; performing gamma correction on the first blurred image and the first texture feature image separately to generate a second blurred image and a second texture feature image; and merging the second blurred image and the second texture feature image to generate a final image with enhanced features.

The disclosure further provides an electronic device, including a storage device and a processing device. In the electronic device, the storage device stores at least one original image. The processing device is electrically connected to the storage device. The processing device blurs the original image to obtain a first blurred image and calculates a difference between the original image and the first blurred image to extract a first texture feature image. The processing device performs gamma correction on the first blurred image and the first texture feature image separately to generate a second blurred image and a second texture feature image that are obtained through the correction, and merges the second blurred image and the second texture feature image to generate a final image with enhanced features.

In conclusion, the disclosure provides an image feature enhancement method and an electronic device, and can quickly enhance the texture feature structure of the image to make the image look clearer. In addition, because the calculation is simple, real-time calculation can be performed even on a device with poor hardware performance. Furthermore, when the disclosure is applied to medical imaging, an image with an abnormal feature is highlighted without using an additional light source. In addition, the disclosure is also used for pre-processing and data augmentation for an artificial intelligence model, to improve performance of the model in case of different light sources.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an electronic device according to an embodiment of the disclosure;

FIG. 2 is a schematic flowchart of an electronic device performing an image feature enhancement method according to an embodiment of the disclosure;

FIG. 3 is a schematic flowchart of an electronic device performing an image feature enhancement method according to another embodiment of the disclosure;

FIG. 4A is a schematic diagram of an actual original image used by an electronic device according to an embodiment of the disclosure;

FIG. 4B is a schematic diagram of an actual final image generated by an electronic device according to an embodiment of the disclosure;

FIG. 4C is a schematic diagram of an actual stylized image generated by an electronic device according to an embodiment of the disclosure;

FIG. 5A is a schematic diagram of an actual original image used by an electronic device according to another embodiment of the disclosure;

FIG. 5B is a schematic diagram of an actual final image generated by an electronic device according to another embodiment of the disclosure; and

FIG. 5C is a schematic diagram of an actual stylized image generated by an electronic device according to another embodiment of the disclosure.

### DETAILED DESCRIPTION OF THE EMBODIMENTS

The following provides detailed descriptions of preferred embodiments. However, the embodiments are merely used as examples for description and are not intended to restrict the protection scope of the disclosure. In addition, some elements are omitted in the drawings in the embodiments, to clearly show technical features of the disclosure. The same reference numerals are used to represent the same or similar components in all drawings.

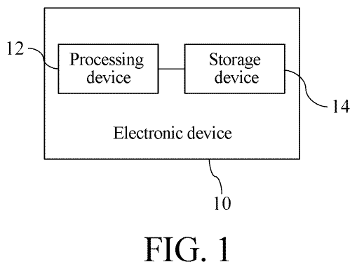

Refer to FIG. 1. An electronic device 10 includes a processing device 12 and a storage device 14, and the processing device 12 is electrically connected to the storage device 14 to access data. In the electronic device 10, the storage device 14 stores at least one original image, including one or more original images. One original image is used as an example here. The processing device 12 reads the original image from the storage device 14 and starts to enhance image features of the original image. First, the processing device 12 blurs the original image to obtain a first blurred image and calculates a difference between the original image and the first blurred image to extract a first texture feature image. Next, the processing device 12 performs gamma correction on the first blurred image and the first texture feature image separately to balance image brightness and enhance features, so as to generate a second blurred image and a second texture feature image that are obtained through the correction. The processing device 12 then merges the second blurred image and the second texture feature image to generate a final image with enhanced features.

In an embodiment, the electronic device 10 is an electronic device, like a personal computer, a notebook computer, or a tablet computer that independently performs matrix calculation. The disclosure is not limited thereto.

In an embodiment, the processing device 12 is a central processing unit (CPU), another general-purpose or special-purpose microprocessor, microcontroller, micro control unit (MCU), digital signal processor (DSP), programmable controller, or application-specific integrated circuit (ASIC), or another similar component or a combination of the above components. The disclosure is not limited thereto.

In an embodiment, the storage device 14 is any type of fixed or removable random access memory (RAM), read-only memory (ROM), flash memory, hard disk drive (HDD), or solid-state drive (SSD), or another similar component or a combination of the above components, for storing any images or data required by the processing device 12. The disclosure is not limited thereto.

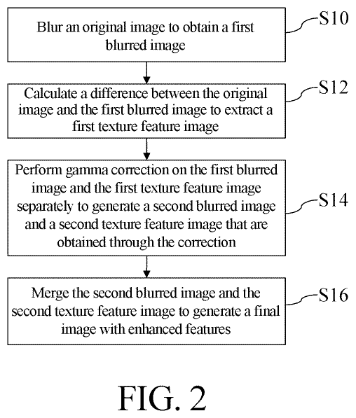

In the electronic device 10, the processing device 12 uses software to execute an algorithm including an image feature enhancement method. Refer to FIG. 1 and FIG. 2 together. As shown in step S10, after an original image is input, the processing device 12 blurs the original image. In this case, to achieve real-time calculation, the processing device 12 uses a mean blurring method to blur the original image to obtain a first blurred image.

As shown in step S12, the processing device 12 calculates a difference between the original image and the first blurred image to extract a first texture feature image. The processing device 12 calculates the difference by using a deconvolution method, as shown in the following Equation (1), to extract the first texture feature image. In Equation (1), F represents the first texture feature image, I represents the original image, and B represents the first blurred image.

$$F = \frac{I}{B} \qquad ( 1 )$$

As shown in step S14, the processing device 12 performs gamma correction (γ) on the first blurred image and the first texture feature image separately, and the gamma correction is used to balance image brightness and enhance features, as shown in the following Equation (2), so as to generate a second blurred image and a second texture feature image that are obtained through the correction. In Equation (2), B′ represents the second blurred image, and F′ represents the second texture feature image.

$$\{ \begin{matrix}{B}^{′} = {B}^{γ} \\ {F}^{′} = {F}^{γ}\end{matrix} \qquad ( 2 )$$

As shown in step S16, the processing device 12 merges the second blurred image and the second texture feature image that are obtained through the correction to generate a final image with enhanced features. The processing device 12 performs the merging by using a deconvolution method, as shown in the following Equation (3), to generate the final image. In Equation (3), O represents the final image with enhanced features.

$$O = {B}^{′} \times {F}^{′} \qquad ( 3 )$$

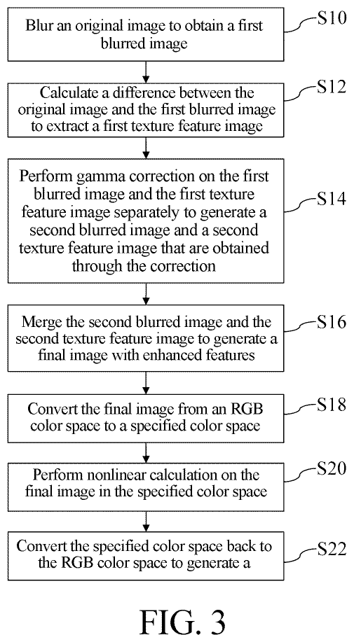

After the final image with enhanced features is obtained, nonlinear calculation is further performed on the final image in different color spaces to generate a stylized image. Refer to FIG. 1 and FIG. 3 together. After the final image is obtained according to step S10 to step S16, as shown in step S18, the processing device 12 then converts the final image from an RGB color space to a specified color space. The specified color space is a YUV color space, a YCbCr color space, or the like. The disclosure is not limited thereto. In this embodiment, the specified color space is the YUV color space to facilitate subsequent operations. As shown in step S20, in the specified color space, the processing device 12 performs nonlinear calculation on the final image, as shown in the following Equation (4). Finally, as shown in step S22, the processing device 12 converts the specified color space back to the RGB color space, that is, converts the YUV color space back to the RGB color space to generate a special stylized image.

$${C}^{′} = \{ \begin{matrix}\frac{{y}_{i + 1} - {y}_{i}}{{x}_{i + 1} - {x}_{i}} \times ( C - {x}_{i + 1} ) + {y}_{i + 1} & if {x}_{i} \leq C < {x}_{i + 1} \\ C & otherwise\end{matrix} , where \qquad ( 4 )$$

$$i ∈ \{ 0 , 1 \}$$

$${x}_{0} = {y}_{0}$$

$${x}_{2} = {y}_{2}$$

$${x}_{0} < ( {x}_{1} , {y}_{1} ) < {x}_{2} .$$

In Equation (4), C is a color value (a pixel value) of one channel of the final image O obtained through color space conversion. C′ is a calculated new color value. x₀, x₁, and x₂ are positions of an original color value. x₀ and x₂ are two endpoints of a range. x₁ is a color value between the two endpoints. y₀, y₁, and y₂ are color values obtained through color space conversion, and correspond to positions of x₀, x₁, and x₂, respectively. x₀=y₀ and x₂=y₂ indicate that at the two endpoints of the range, the original color value and the converted color value are the same. x₀<(x₁, y₁)<x₂ indicates that x₁ and y₁ are between x₀ and x₂. When C>x₂ or C<x₀, C′=C is set directly, so that a converted color value is the same as an original color value. In addition, because x₀=y₀ and x₂=y₂, this design avoids discontinuities in color values when the color values are out of range.

In Equation (4), each part has its own meaning.

$$\frac{{y}_{i + 1} - {y}_{i}}{{x}_{i + 1} - {x}_{i}}$$

is a rate (slope) or a color change, and indicates a change in a y-value corresponding to each unit change in an x-value between xᵢ and xᵢ₊₁. (C−xᵢ₊₁) is used to calculate a distance between C and an endpoint xᵢ₊₁. Because xᵢ≤C<xᵢ₊₁, a value of this distance is negative, but still represents a leftward distance from the endpoint xᵢ₊₁ to C. Finally, yᵢ₊₁ is added. In this way, it is ensured that in the calculation process, adjustment is started with a known color value, and then a new color value is calculated based on the position of C.

It is assumed that x₀=0, x₁=50, and x₂=100, and it is assumed that y₀=0, y₁=75, and y₂=100. When C=25 (which is between x₀ and x₁), C′=(75−0)/(50−0)*(25−50)+75=1.5*(−25)+75=−37.5+75=37.5. When C=75 (which is between x₁ and x₂), C′=(100−75)/(100−50)*(75−100)+100−0.5*(−25)+100=−12.5+100=87.5. When C>100 or C<0, C′=C is set directly. In this case, a color value of C′ is consistent with the original color value, to avoid discontinuities in color values. This calculation method ensures that color transition is smooth and continuous across the entire color range, to avoid breakpoints.

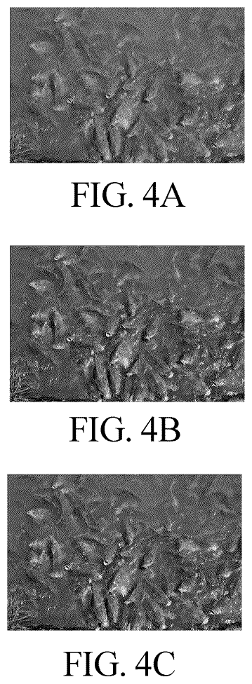

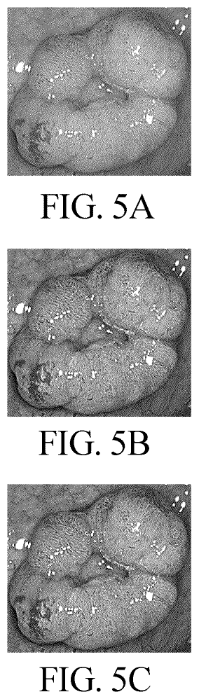

Refer to FIG. 3 and FIG. 4A to FIG. 4C. In general imaging, the original image before being processed by using the method of the disclosure is shown in FIG. 4A, the final image generated in step S16 is shown in FIG. 4B, and the stylized image generated in step S22 is shown in FIG. 4C. It is learned from the figures that definition of the final image obtained through feature enhancement is indeed higher than that of the original image, and the stylized image not only has high definition, but also has a specific level of color saturation. Refer to FIG. 3 and FIG. 5A to FIG. 5C. In medical imaging, the original image before being processed by using the method of the disclosure is shown in FIG. 5A, the final image generated in step S16 is shown in FIG. 5B, and the stylized image generated in step S22 is shown in FIG. 5C. It is learned from the figures that definition of the final image obtained through feature enhancement is indeed higher than that of the original image, and the stylized image not only has high definition, but also has a specific level of color saturation.

Therefore, compared with the conventional method, the disclosure has the following advantages: 1. The calculation method of the disclosure is simple, supports real-time running on a device with poor hardware performance, and does not require expensive high-performance hardware. 2. The disclosure provides real-time image processing, avoiding tedious and complicated post-processing steps and eliminating likelihood of needing to recapture an image. 3. In medical imaging, there is no need to use an additional light source device (like in narrow band imaging), so that costs and a risk of device damage are reduced. 4. The disclosure is used as a pre-processing and data augmentation tool for an artificial intelligence model, to improve performance of the model in case of different light sources.

In conclusion, the disclosure provides an image feature enhancement method and an electronic device, and can quickly enhance the texture feature structure of the image to make the image look clearer. In addition, because the calculation is simple, real-time calculation can be performed even on a device with poor hardware performance. Furthermore, when the disclosure is applied to medical imaging, an image with an abnormal feature is highlighted without using an additional light source. In addition, the disclosure is also used for pre-processing and data augmentation for an artificial intelligence model, to improve performance of the model in case of different light sources.

Embodiments described above are only for illustrating the technical ideas and features of the disclosure. An objective of the embodiments is to make a person skilled in the art understand the content of the disclosure and implement the disclosure accordingly. The embodiments are not intended to limit the patent scope of the disclosure. In other words, any equivalent changes or modifications made based on the spirit of the disclosure shall fall within the patent scope claimed by the disclosure.

What is claimed is:

1. An image feature enhancement method, comprising:
blurring an original image to obtain a first blurred image;
calculating a difference between the original image and the first blurred image to extract a first texture feature image;
performing gamma correction on the first blurred image and the first texture feature image separately to generate a second blurred image and a second texture feature image that are obtained through the correction; and
merging the second blurred image and the second texture feature image to generate a final image with enhanced features.

2. The image feature enhancement method according to claim 1, wherein in the step of blurring the original image, mean blurring processing is performed on the original image to obtain the first blurred image.

3. The image feature enhancement method according to claim 1, wherein in the step of calculating the difference between the original image and the first blurred image, the difference is calculated by using a deconvolution method to extract the first texture feature image.

4. The image feature enhancement method according to claim 1, wherein in the step of merging the second blurred image and the second texture feature image, merging is performed by using a deconvolution method to generate the final image.

5. The image feature enhancement method according to claim 1, further comprising: performing nonlinear calculation on the final image in different color spaces to generate a stylized image.

6. The image feature enhancement method according to claim 5, wherein the step of performing the nonlinear calculation on the final image in different color spaces further comprises: converting the final image from an RGB color space to a specified color space; performing the nonlinear calculation on the final image in the specified color space; and converting the specified color space back to the RGB color space to generate the stylized image.

7. The image feature enhancement method according to claim 6, wherein the specified color space is a YUV color space or a YCbCr color space.

8. An electronic device, comprising:
a storage device, storing at least one original image; and
a processing device, electrically connected to the storage device, wherein the processing device blurs the original image to obtain a first blurred image and calculates a difference between the original image and the first blurred image to extract a first texture feature image; and the processing device performs gamma correction on the first blurred image and the first texture feature image separately to generate a second blurred image and a second texture feature image that are obtained through the correction, and merges the second blurred image and the second texture feature image to generate a final image with enhanced features.

9. The electronic device according to claim 8, wherein the processing device performs mean blurring processing on the original image to obtain the first blurred image.

10. The electronic device according to claim 8, wherein the processing device calculates the difference between the original image and the first blurred image by using a deconvolution method to extract the first texture feature image.

11. The electronic device according to claim 8, wherein the processing device merges the second blurred image and the second texture feature image by using a deconvolution method to generate the final image.

12. The electronic device according to claim 8, wherein the processing device further performs nonlinear calculation on the final image in different color spaces to generate a stylized image.

13. The electronic device according to claim 12, wherein the processing device further converts the final image from an RGB color space to a specified color space;
performs the nonlinear calculation on the final image in the specified color space; and
converts the specified color space back to the RGB color space to generate the stylized image.

14. The electronic device according to claim 13, wherein the specified color space is a YUV color space or a YCbCr color space.
